(19) United States
(12) Patent Application Publication
(10) Pub. No.: US 2020/0003309 A1
(43) Pub. Date: Jan. 2, 2020

(54) Seal Carrier and Turbomachine

(71) Applicant: MTU Aero Engines AG, Muenchen (DE)

(72) Inventors: Joachim BAMBERG, Dachau (DE); Stefan NEUHAEUSLER, Thierhaupten (DE); Benjamin HENKEL, Muenchen (DE); Dominik BROSZAT, Unterfoehring (DE)

(21) Appl. No.: 16/420,333

(22) Filed: May 23, 2019

(30) Foreign Application Priority Data
May 23, 2018 (DE) 102018208040.2

(51) Int. Cl. F16J 15/16; F02C 7/28

(52) U.S. Cl. CPC F16J 15/164; F02C 7/28; F05D 2230/237; F05D 2220/323; F05D 2250/283; F23R 2900/00014; F05D 2240/55

(57) ABSTRACT

A seal carrier for a turbomachine for sealing a gap between a stator section and a rotor section, having a base body, which is provided on one side with a run-in coating; the base body at least having one hollow space, which is open via at least one opening to the run-in coating, creating a Helmholtz resonator; the area of the run-in coating, which is provided with the at least one opening, providing the oscillating mass of the Helmholtz resonator, and the at least one hollow space, the spring volume thereof.

This claims the benefit of German Patent Application DE102018208040.2, filed May 23, 2018 and he

The present invention relates to a seal carrier for a turbomachine, for example, an aircraft engine, as well as a turbomachine.

### BACKGROUND

In the case of turbomachines, such as gas and steam turbines, gaps between rotating and static machine parts are routinely sealed in order to prevent secondary flow losses. This holds, for example, for sealing radial gaps between the radial inner ends of guide vanes and an opposite rotor section (inner air seal) or between radially outer ends of rotor blades and an opposite stator section (outer air seal). During operation of the turbomachine and also as the result of flying maneuvers, the rotor sections or the stator sections are ordinarily in frictional contact with opposite run-in or abradable coatings, thereby effecting, inter alia, a gap closing. The aerodynamic interaction of the rotor and stator blades produce pressure fluctuations in the turbomachine, which are also perceived as noise in the ambient environment.

### SUMMARY OF THE INVENTION

It is an object of the present invention to provide a seal carrier for a turbomachine, such as an aircraft engine, which will overcome the aforementioned disadvantages and make it possible to reduce noise during operation. It is also an object of the present invention to provide a turbomachine, which, with the same design, will produce less noise than conventional turbomachines.

The present invention provides a seal carrier for a turbomachine, for example, an aircraft engine or a stationary gas turbine, for sealing a gap between a stator section and a rotor section has a base body, which is provided on one side with a run-in coating. In accordance with the present invention, the base body has at least one hollow space, which is open via at least one opening on the side receiving the run-in coating.

By providing the hollow body, in combination with the run-in coating, the present invention integrates a Helmholtz resonator in the seal carrier. The Helmholtz resonator converts sound energy from the ambient environment into thermal energy, thereby damping sound and, thus, reducing noise during abrading. A Helmholtz resonator is essentially composed of a volume that communicates via a neck with the external environment. In the case of the seal carrier according to the present invention, the volume is provided by the hollow space, and the neck by the run-in coating. Especially effective damping results are attainable for low-frequency sound. Sound frequencies that are perceptible to the human ear, in particular frequencies in the single-digit and low two-digit kilohertz range, in particular, frequencies of 40 Hz to 10 kHz, are primarily considered to be low frequency. In the case of the Helmholtz resonator, whether the sound is low-frequency is dependent on the length of the volume and the neck length, as well as on whether the neck diameter or the neck cross-sectional area is small in comparison with the wavelength. Preferably, the design of the seal carrier is such that frequencies in the commonly occurring range of 1 kHz to 6 kHz are absorbed at a temperature of approximately 1000° C. The seal carrier is preferably manufactured additively. This makes it possible to optimally adjust the absorption capacity of the Helmholtz resonator which, in accordance with the present invention, is intrinsic to the seal carrier.

An exemplary embodiment provides a multitude of hollow spaces. The absorption capacity of the seal carrier may be selectively influenced by modifying the number and/or the volume of the hollow spaces. For example, to adjust the absorption capacity and, in particular, to adjust the natural frequency relevant thereto, one or a plurality of additional space(s) may be used at the rear to enlarge or lengthen the at least one hollow space.

A multiplicity of openings may be formed on the side that receives the run-in coating. This likewise makes possible an adaptation to the frequencies to be damped.

In an exemplary embodiment, the run-in coating has a cellular structure that is composed of a plurality of honeycomb cells. Preferably at least a few honeycomb cells have individual openings associated therewith. These honeycomb cells may function as necks of the Helmholtz resonator, the form and dimensions thereof being able to selectively influence the absorption capacity. At the same time, the honeycomb structure makes it possible for a lambda quarter-wave absorber to also be provided. It functions in addition to the Helmholtz resonator. A lambda quarter-wave absorber is a hollow space of the honeycomb structure that is open to one side and has a greatest extent in a depth direction, thus in a radial direction of the turbomachine, and, across this extent in the depth direction, is able to at least partially eliminate the entering sound waves. The absorption effect of the lambda quarter-wave absorber and that of the Helmholtz resonator may be advantageously combined.

Alternatively or additionally, the run-in coating may have a cellular structure, and an opening extend over a plurality of cells, for example, honeycomb cells. This makes it possible to provide openings whose opening area is greater than a cell base area.

In another exemplary embodiment, the side receiving the run-in coating is designed as a grid, the run-in coating extending along grid struts. This measure makes it possible to provide a multiplicity of openings.

From the sound-reduction perspective, it is beneficial when the side receiving the run-in coating has a total surface area whose opening-free surface sections are cumulatively greater than a perforated surface area, which is made up of the sum of opening areas of the openings.

It is especially favorable when the proportion of the perforated surface area is ≤30% of the total surface area, more preferably ≤20% of the total surface area.

As a further measure for reducing sound, it may be advantageous for a damping means to be introduced into the at least one opening and/or the at least one hollow space. An exemplary damping means is a temperature-resistant nonwoven material or an open-cell foam, in particular an open-cell metal foam.

A turbomachine according to the present invention, such as an aircraft engine, has a seal carrier assembly, which is provided for sealing a gap between a stator section and a rotor section and includes a multiplicity of seal carriers according to the present invention. This measure reduces tonal components of the alternating frequencies of the airfoil in the “outer air seal region” or in the “inner air seal region.” Thus, in comparison to a conventional turbomachine, the inventive turbomachine of the same design has the distinguishing feature of a noise-reducing operation.

Other advantageous exemplary embodiments of the present invention constitute the subject matter of further dependent claims.

### BRIEF DESCRIPTION OF THE DRAWINGS

Preferred exemplary embodiments of the present invention are described in greater detail below with reference to highly simplified schematic drawings, in which:

FIG. 1 is a perspective view of an exemplary embodiment of a seal carrier according to the present invention;

FIG. 2 is an axial view of an exemplary embodiment of a seal carrier assembly according to the present invention in the assembled state, in a turbomachine;

FIG. 3 is a detail view of a hollow space of the seal carrier from FIG. 1;

FIG. 4 is a detail view of a hollow space of a second exemplary embodiment of the seal carrier according to the present invention;

FIG. 5 is a plan view of the run-in coating of the seal carrier from FIG. 1 having a first exemplary configuration of openings; and

FIG. 6 is a plan view of the run-in coating of the first exemplary embodiment of FIG. 1 having a second exemplary configuration of openings.

### DETAILED DESCRIPTION

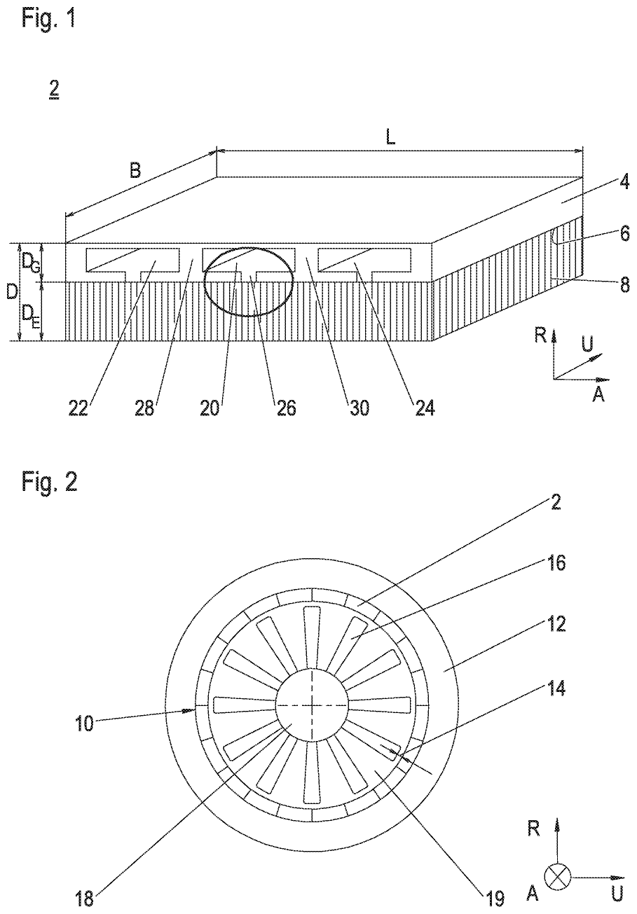

FIG. 1 shows a perspective view of an inventive seal carrier 2 for a turbomachine. The turbomachine is an aircraft engine, a stationary gas turbine, an industrial gas turbine, a marine propulsion turbine or a steam turbine, for example.

Seal carrier 2 has a base body 4, on whose one side 6, a run-in coating 8 is provided over the entire surface area. Seal carrier 2 is preferably additively manufactured by selective laser melting, for example. Thus, base body 4 and run-in coating 8 are produced in one process and integrally joined together. Additive manufacturing eliminates the need for conventional separate manufacturing of base body 4 and of run-in coating and for subsequent attachment to base body 4, for example, by brazing.

As indicated in FIG. 2, seal carrier 2, in combination with substantially identical seal carriers 2, forms a seal carrier assembly 10 that is joined to form a ring. Here, seal carrier assembly 10 is in the form of what is generally referred to as an “outer air seal.” It is self-evident that it may also be in the form of what is generally referred to as an “inner air seal.” Seal carrier assembly 10 may be configured on the compressor side or turbine side. In the variant shown here as an “outer air seal,” it is preferably configured on the turbine side, in particular in the rear turbine section or in the low-pressure turbine.

Seal carrier assembly 10 is configured in a stator section 12 and, in each case, seals a radial gap 14 to an opposite rotor section 16. Rotor sections 16 are rotor blades, which are mounted on a rotor shaft 18 that rotates about a longitudinal machine axis. By run-in coatings 8 thereof, seal carriers 2 are thereby oriented to point toward rotor section 16 and thus radially outwardly bound an annular space 19 traversed by the hot gas stream. At the tip side thereof, rotor sections 16 run into run-in coatings 8 or rub against the same during operation of the turbomachine, closing radial gap 14 in question and preventing the formation of secondary flows.

It is specified with reference to FIG. 1 that thickness D of one of seal carriers 2 in radial direction R, length L of seal carrier 2 in axial direction A, and width B of seal carrier 2 in circumferential direction U of the turbomachine are abraded. Thickness D of seal carrier 2 is made up of thickness D_{G} of base body 4 and of thickness D_{E} of run-in coating 8. Axial direction A, radial direction R, and circumferential direction U generally relate to the longitudinal machine axis and thus to the axis of rotation of rotor shaft 16 corresponding to the longitudinal machine axis. It is also noted that the use of the terms “radial direction,” “axial direction,” and “circumferential direction” likewise include the designations “substantially in the radial direction,” “substantially in the axial direction,” and “substantially in the circumferential direction.”

An exemplary seal carrier 2 has a length L of 10 cm, a width B of 10 cm, and a thickness D_{G} of 1 cm.

Base body 4 has a middle hollow space 20, a front hollow space 22, disposed upstream of middle hollow space 20 in the direction of flow, and a rear hollow space 24, disposed downstream in the direction of flow. Hollow spaces 20, 22, 24 are peripherally closed and merely open toward annular space 19, in each case via at least one opening 26 in side 6 that receives run-in coating 8. Thus, hollow spaces 20, 22, 24 are open toward run-in coating 8. Hollow spaces 20, 22, 24 preferably have the greatest extent thereof in the direction of width B of base body 4 (circumferential direction U) and are laterally closed. However, it is also fundamentally possible for hollow spaces 20, 22, 24 to be laterally open, so that a single seal carrier 2 does not have hollow spaces 20, 22, 24 specific thereto, rather, considered in circumferential direction U, hollow spaces 20, 22, 24 extend over adjacent seal carriers 2, so that hollow spaces 20, 22, 24 are simultaneously associated with a plurality of seal carriers, or merely one hollow space portion is formed by a single seal carrier 2.

In the exemplary embodiment shown here, the three hollow spaces 20, 22, 24 are each fluidically separated from one another by a partition wall 28, 30 that extends in circumferential direction U. However, it is also conceivable to fluidically join the three hollow spaces 20, 22, 24 to one another, forming merely one hollow space 20, 22, 24 in seal carrier 2 or in base body 4 thereof. In accordance with the present invention, hollow spaces 20, 22, 24, in combination with the at least one opening 26, serve as Helmholtz resonators and reduce noise, preferably under cruising conditions or during take off and landing.

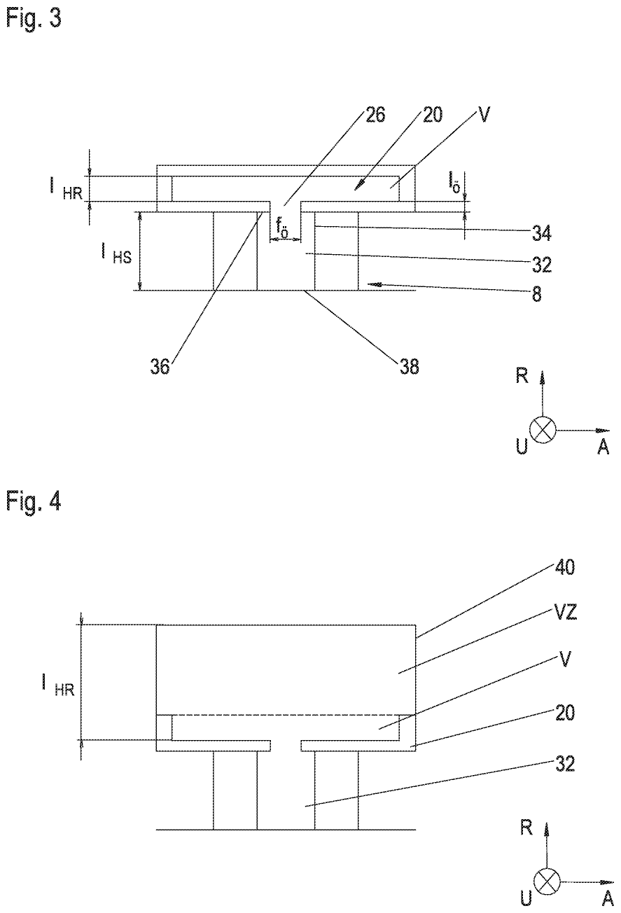

As middle hollow space 20 illustrates representatively in FIG. 3 for front and rear hollow spaces 22, 24 as well, hollow space 20 has a volume V having a length l_{HR} that is abraded in radial direction R. Hollow space 20 exemplarily has a rectangular shape here, with the greatest extent thereof in circumferential direction U and the smallest extent thereof in radial direction R.

Run-in coating 8 is formed here as a cellular structure, in particular as a honeycomb structure, which has a multiplicity of individual, preferably equal size cells, in this case honeycomb cells 32. Each honeycomb cell 32 is bounded by a honeycomb wall 34, which extends from a honeycomb base area 36 on base body 4 orthogonally across a length l_{HS} up to a mouth region 38 of the particular honeycomb cell 32. Thus, honeycomb cell 32 is open to annular space 19 (FIG. 2). Opening 26 extends through honeycomb base area 36 and thus effects a fluid communication between hollow space 20 and honeycomb cell 32. Honeycomb base area 36 may assume any shape. It is not limited to the quadrangular or square shape shown in the figures, rather may also be rectangular or circular, for example.

Honeycomb cell 32, in whose honeycomb base area 36, an opening 26 to hollow space 20 is introduced, acts with honeycomb wall 34 thereof, as a neck of the Helmholtz resonator, and hollow space 20 as volume V of the Helmholtz resonator. A Helmholtz resonator usually features a hollow space having a neck via which the hollow space volume is able to communicate with the external environment. Especially advantageous noise reductions may be achieved by carefully selecting the size of the volume of the hollow space and the length, as well as the cross-sectional opening area of the neck. The air in the neck forms an inertial mass, which, together with the air in the hollow space, produces a spring-mass system, the air in the hollow space constituting the spring. The maximum absorption occurs in the range of the natural frequency of the Helmholtz resonator. A Helmholtz resonator has a high absorption capacity at low-frequency sound, in particular. In principle, the sound is low-frequency when the length of the hollow space, the length of the neck, and the opening area or the cross-sectional opening area of the neck are small in comparison to the wavelength.

Applying this to seal carrier 2 according to the present invention, in highly simplified terms, hollow space 20 provides “spring volume” V, and honeycomb cell 32, the resonator neck, and thus the inertial mass. Not discussed in further detail is the basic application of the operating principle being influenced by opening area f_{Ö} of opening 26 and by length l_{Ö} of opening 26. Frequencies in the exemplary embodiment shown here are within the range of from 1 kHz to 6 kHz, for example. An exemplary seal carrier temperature in the low-pressure turbine is 1000° C. As indicated in FIG. 4, to adjust the absorption frequencies, length l_{HR} of hollow space 20 may be increased by an additional rear space 40. Alternatively, length l_{HR} of hollow space 20 may also be reduced.

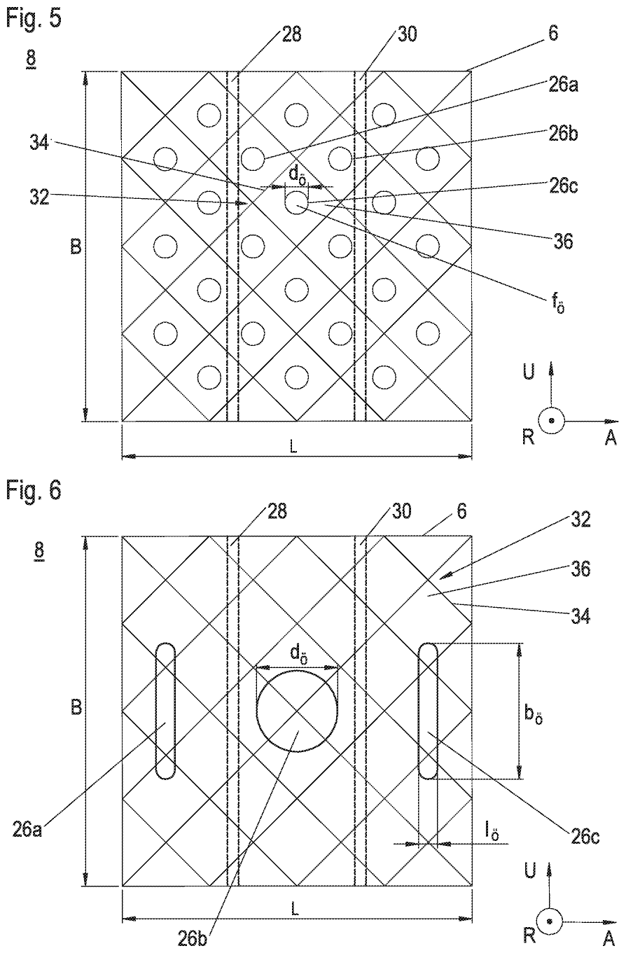

FIG. 5 shows an exemplary embodiment of a possible formation of openings 26a, b, c. The representation of openings 26a, b, c serves merely to show a possible exemplary, but not limiting hole pattern.

In the exemplary embodiment shown here, a single opening 26a, b, c is associated with each complete honeycomb cell 32. Openings 26a, b, c are each disposed in the middle of honeycomb base areas 36 and have a constant diameter d_{Ö} and thus a circular opening area f_{Ö}. The sum of opening areas 26a, 26b, 26c over side 6 yields a perforated surface area.

Essentially, side 6 that receives run-in coating 8 has a total surface area that is determined by width B and length L of base body 4 and is made up of the sum of honeycomb base areas 36. Essentially, the perforated surface area is smaller than the opening-free total surface sections. The proportion of the perforated surface is preferably ≤30% of the total surface area, more preferably ≤20%.

It should also be noted that honeycomb cells 32 may also merge in a funnel shape into openings 26a, b, c, thus that honeycomb base area 36 is formed by particular opening area f_{Ö}. When openings 26a, b, c have a correspondingly large opening area f_{Ö}, or when honeycomb cells 32 have a correspondingly small honeycomb base area 36, honeycomb cells 32 may also merge into openings 26a, b, c, orthogonally to side 6, provided that opening areas f_{Ö} and honeycomb base areas 36 have the same circumferential form.

FIG. 6 shows an alternative exemplary embodiment of a honeycomb-type run-in coating 8. The representation of openings 26a, b, c serves merely to show a possible exemplary, but not limiting hole pattern.

Provided in middle hollow space 20 in this exemplary embodiment is an opening 26a that extends over a plurality of honeycomb cells 32 and is designed to have a circular form with a constant diameter d_{Ö}. Front and rear hollow spaces 22, 24 are each provided with an opening 26a, c in the form of an elongated hole. Elongated hole-type openings 26a, c are identical in design and have a width b_{Ö} and a length l_{Ö}. Elongated hole-type openings 26a, c are essentially positioned along circumferential direction U and likewise extend over a plurality of honeycomb cells 32.

The ratio between the perforated surface area and the total surface area, sketched in FIG. 5, also holds for FIG. 6.

Described is a seal carrier for a turbomachine for sealing a gap between a stator section and a rotor section, having a base body, which is provided on one side with a run-in coating; the base body at least having a hollow space, which is open via at least one opening to the run-in coating, creating a Helmholtz resonator; the area of the run-in coating, which is provided with the at least one opening, providing the oscillating mass of the Helmholtz resonator, and the at least one hollow space, the spring volume thereof.

### LIST OF REFERENCE NUMERALS

2 seal carrier
4 base body
6 side
8 run-in coating
10 seal carrier assembly
12 stator section
14 radial gap
16 rotor section/rotor blade
18 rotor shaft
19 annular space
20 middle hollow space
22 front hollow space
24 rear hollow space
26, a, b, c openings
28 partition wall
30 partition wall
32 cell/honeycomb cell
34 honeycomb wall
36 cell base area/honeycomb base area
38 mouth region
40 additional space
A axial direction
R radial direction
U circumferential direction
B width of the seal carrier, extent in the circumferential direction
D thickness of the seal carrier, extent in the radial direction
D_{G} base body thickness
D_{E} run-in coating thickness
L length of the seal carrier, extent in the axial direction
b_{Ö}width of the openings
d_{Ö}diameter of the openings
f_{Ö}opening area of the openings
l_{HR} length of the hollow space
l_{HS} length of the cell/honeycomb cell
l_{Ö}length of the openings
V volume
V_{Z} additional volume

What is claimed is:

1-10. (canceled)

11. A seal carrier for a turbomachine for sealing a gap between a stator section and a rotor section, the seal carrier comprising:
a run-in coating; and
a base body provided on one side with the run-in coating, the base body having at least one hollow space open via at least one opening on the side receiving the run-in coating.

12. The seal carrier as recited in claim 11 wherein the base body includes a plurality of hollow spaces.

13. The seal carrier as recited in claim 11 wherein the at least one opening includes a plurality of openings.

14. The seal carrier as recited in claim 13 wherein the run-in coating having a cellular structure with cells and individual openings of the plurality of openings are associated with at least some of the cells.

15. The seal carrier as recited in claim 11 wherein the run-in coating has a cellular structure and the opening extends over a plurality of cells.

16. The seal carrier as recited in claim 11 wherein the side receiving the run-in coating is designed as a grid with grid struts, and the run-in coating extends along grid struts.

17. The seal carrier as recited in claim 11 wherein the side receiving the run-in coating has a total surface area with opening-free surface sections cumulatively greater than a perforated surface area corresponding to a sum of opening areas of the at least one opening.

18. The seal carrier as recited in claim 17 wherein a proportion of the perforated surface area is ≤30% of the total surface area.

19. The seal carrier as recited in claim 17 wherein a proportion of the perforated surface area is ≤20% of the total surface area.

20. The seal carrier as recited in claim 11 further comprising a damper is introduced into the at least one opening or into the at least one hollow space.

21. A turbomachine comprising a seal carrier assembly for a turbomachine for sealing a gap between a stator section and a rotor section and having a plurality of seal carriers as recited in claim 11.
